(19) United States
(12) Patent Application Publication
(10) Pub. No.: US 2006/0200398 A1
(43) Pub. Date: Sep. 7, 2006

(54) Accounting integrity verification method and apparatus

(76) Inventors: Ronnie Botton, Herzlia (IL); Daniel Eisenband, Tel-Aviv (IL); Dori Eisenband, Tel-Aviv (IL)

Correspondence Address: Martin D. Moynihan;PRTSI, Inc., P.O. Box 16446, Arlington, VA, 22215, US

(21) Appl. No.: 11/365,940

(22) Filed: Mar. 2, 2006

Related U.S. Application Data
(60) Provisional application No. 60/657,728, filed on Mar. 3, 2005.

(51) Int. Cl. G06Q 40/00

(52) U.S. Cl. 705/35

(57) ABSTRACT

Verification unit for financial accounting comprising: a first input for receiving a financial account in electronic format, a second input for obtaining parameters used for preparing said financial account, a processing unit for independently carrying out accounting based on the data in the financial account and the obtained parameters, a comparator for comparing the input financial account with the independently carried out accounting to verify the input financial account, and an output associated with the comparator for outputting the results of the comparison.

### RELATED APPLICATION

The present application claims the benefit of U.S. Provisional Patent Application No. 60/657,728, filed on Mar. 3, 2005, the contents of which are hereby incorporated by reference.

### FIELD AND BACKGROUND OF THE INVENTION

The present invention relates to an accounting integrity verification method and apparatus and, more particularly, but not exclusively to an independent arrangement available to users over a network that verifies accounts as a service.

Most people have dealings with some kind of financial institution and receive regular accounts. The accounts are often detailed and incorporate charges, commissions, interest and the like which are calculated in very precise ways but which calculations are often not fully apparent to the customer.

Customers generally do not have a high level of faith in the financial institutions but typically do not have the knowledge or the time to be able to check the details of the calculations used in their accounts. A system that could independently verify the accounts would greatly increase confidence among ordinary members of the public in the financial institutions.

Furthermore, banks and other lending and financial institutions make mistakes, for example regarding value dates, interest rates and periods, computations, debits and credits, and more, and in general their mistakes cost their customers billions of dollars in overcharges or lost interest income each year. Auditing interest charges and credits is a tedious and time-consuming task which in commercial organizations is relegated to costly in-house staff or outside consulting firms. According to Federal Reserve data in the United States, overall credit turnover in the year 2000 was approximately $ 130 trillion. Recent estimates show that the overall error rate amounted to billions of dollars. Certainly for the private user the time and effort that needs to be spent to recover the modest sums that might be involved is often perceived as being out of proportion to the likely benefit, even assuming that the particular user has the necessary skill to be able to make the calculations correctly.

### SUMMARY OF THE INVENTION

According to one aspect of the present invention there is provided a verification unit for financial accounting comprising:

a first input for receiving a financial account in electronic format,

a second input for obtaining parameters used for preparing said financial account,

a processing unit for independently carrying out accounting based on the data in the financial account and the obtained parameters,

a comparator for comparing the input financial account with the independently carried out accounting to verify the input financial account, and

an output associated with the comparator for outputting the results of the comparison.

According to a second aspect of the present invention there is provided a verification unit for financial accounting comprising:

a first input for receiving a financial account in electronic format, the account having been generated using predetermined financial parameters,

a processing unit for independently carrying out accounting based on the data in the financial account in order to derive said predetermined parameters, and

an output associated with the comparator for outputting the derived parameter results.

According to a third aspect of the present invention there is provided a method of providing verification of financial accounting comprising:

receiving a financial account in electronic format,

receiving parameters on which said financial account is supposed to have been based,

independently carrying out accounting using data from said received financial account and said received parameters,

comparing said received account with said independently carried out accounting, and

providing a verification output indicative of said comparing.

According to a fourth aspect of the present invention there is provided a server comprising:

an input unit for receiving financial accounting data and parameters for financial accounting;

a processing unit for recalculating said financial accounting data using said parameters, thereby to verify said received financial accounting data.

According to a fifth aspect of the present invention there is provided a method of doing business comprising:

receiving financial accounting data and parameters for financial accounting from a customer;

receiving payment from said customer;

recalculating said financial accounting data using said parameters; and

providing said customer with verification data of said received financial accounting data.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a verification unit according to a first preferred embodiment of the present invention;

FIG. 2 is a simplified diagram showing a verification unit according to a second preferred embodiment of the present invention;

FIG. 3 is a simplified flow chart illustrating operation of the embodiment of FIG. 1;

FIG. 4 is another simplified flow chart, according to a preferred embodiment of present invention;

FIG. 5 is a screen shot showing a dialog for allowing a user to enter parameters of his account, according to a preferred embodiment of the present invention;

FIG. 6 is a simplified flow chart showing process flow according to a preferred embodiment of the present invention;

FIG. 7 is a simplified flow chart showing a procedure for calculating interest rates according to a preferred embodiment of the present invention;

FIG. 8 is a simplified flow chart showing a procedure for calculating stock commissions according to a preferred embodiment of the present invention.

FIG. 9 is a simplified screen shot showing a file upload dialog box according to a preferred embodiment of the present invention; and

FIGS. 10 and 11 are diagrams showing a report annotating a user account, according to a preferred embodiment of the present invention.

### DESCRIPTION OF THE PREFERRED EMBODIMENTS

The present embodiments comprise an apparatus and a method for verifying bank accounts and other financial information, both in order to increase customer confidence and to ensure that mistakes are painlessly spotted and corrected.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

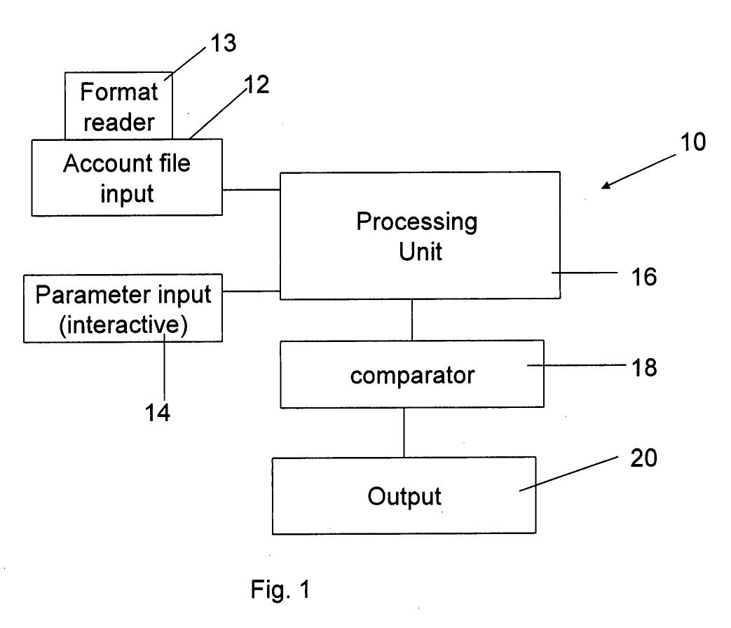

Reference is now made to FIG. 1 which is a simplified verification unit for financial accounting according to a first preferred embodiment of the present invention. Verification unit 10 comprises a first input 12 for receiving a financial account in electronic format, typically a file in Excel™ or PDF format as the user might download directly from the bank website or from other finance software such as MS Money™, Intuit™ or others. The first input preferably includes a format reader 13 for those input formats that cannot be used directly, so as to translate the format into another format that can be used. Thus Excel™ format can most probably be used directly, whereas PDF format would most likely have to be translated.

A second input 14 allows the user to provide parameters from his bank that have been used, or are supposed to have been used, for preparing the financial account, thus rates of interest, conditions under which the rates of interest are calculated etc. The second input is typically an interactive input. However the second input can also receive data directly from the bank. As will be explained below, for financial planning, the second input can be used to provide test parameters made up by the user.

A processing unit 16 then uses the data for independently carrying out accounting based on the data in the financial account and the obtained parameters. The output of the processing unit is passed to a comparator 18 which compares the input financial account with the independently carried out accounting to verify the input financial account. The results of the comparison are then passed to an output unit 20 which generates a report based on the comparison. If the two versions are the same then the report may simply indicate that the bank's calculations are appropriate. If the two versions are different however, the report preferably points out the distinctions.

The report produced by the output is preferably provided to the user as an annotation of the original input report.

In one embodiment the verification unit 10 is provided as a website accessible to users over the internet, so that it serves remote users who download data files to the file input 12 over the Internet and who then fill in a web form interactively to provide the interactive input 14. The website version preferably downloads the results to the user or displays the results on a personalized web page visible only to the particular user. The processing unit typically carries out such tasks as interest accounting, and can verify a declared interest rate, an interest period, an interest start date, or an interest end date, so that the user can easily verify that his bank account has correctly calculated such sums.

The comparison report may simply highlight apparent inconsistencies or may go further and comment on the inconsistencies.

As well as a verification system the unit 10 can also be used for financial planning. That is to say the user can input different combinations of parameters and see what the results are. It is thus possible to apply changes to the data or parameters to achieve best results for the customer. Thus the apparatus provides an account integrity verification and financial planning system.

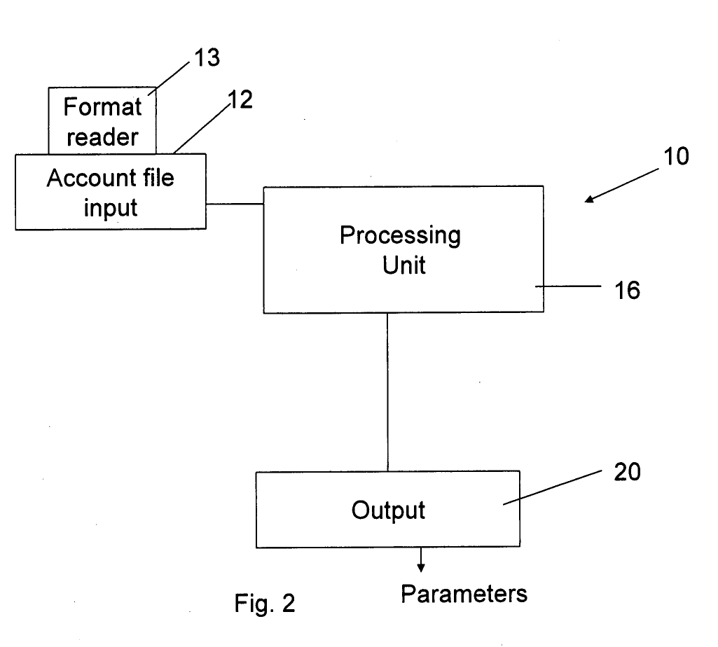

Reference is now made to FIG. 2, which is an alternative embodiment that does not receive parameters from the user. Rather it takes the original bank account and attempts to derive the parameters, such as interest rates, that were used in order to arrive at the account. No comparison is carried out but the processing unit simply derives the parameters. The output unit 20 sends the calculated parameters, which the user can then compare against the declared parameters of the bank or other financial institution.

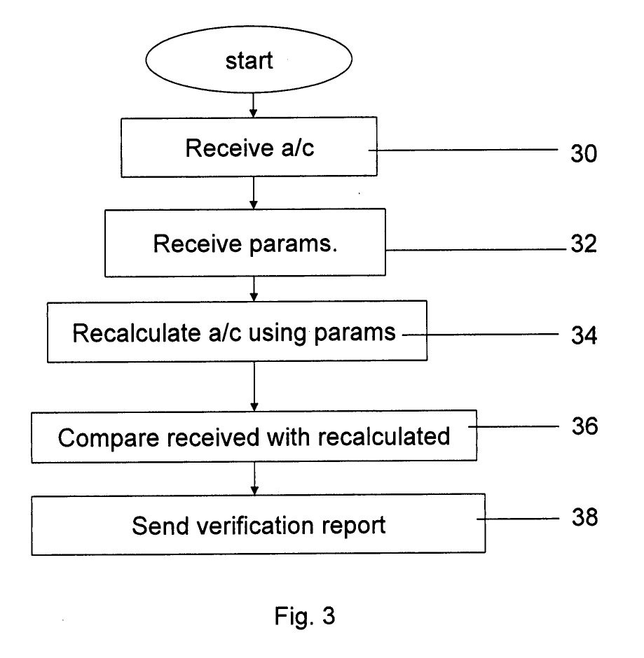

Reference is now made to FIG. 3, which is a simplified flow chart showing a method of providing verification of financial accounting according to a preferred embodiment of the present invention. The method may be carried out at a verification unit such as that shown in FIG. 1. In stage 30 the verification unit receives a financial account in electronic format. In stage 32 the verification unit receives, from the user, the parameters on which the financial account is supposed to have been based.

In stage 34 the unit independently carries out accounting using data from the received financial account and the received parameters. In stage 36 a comparison is made between the received and independently calculated accounts, and in stage 38 a report is sent to the user, as explained above.

As explained a preferred embodiment is a website, in which users opt to send files of their bank accounts for a given period. The user interactively enters the bank rules, parameters, interest rates etc in accordance with guiding questions such as, what is your base interest, ceiling interest rate.

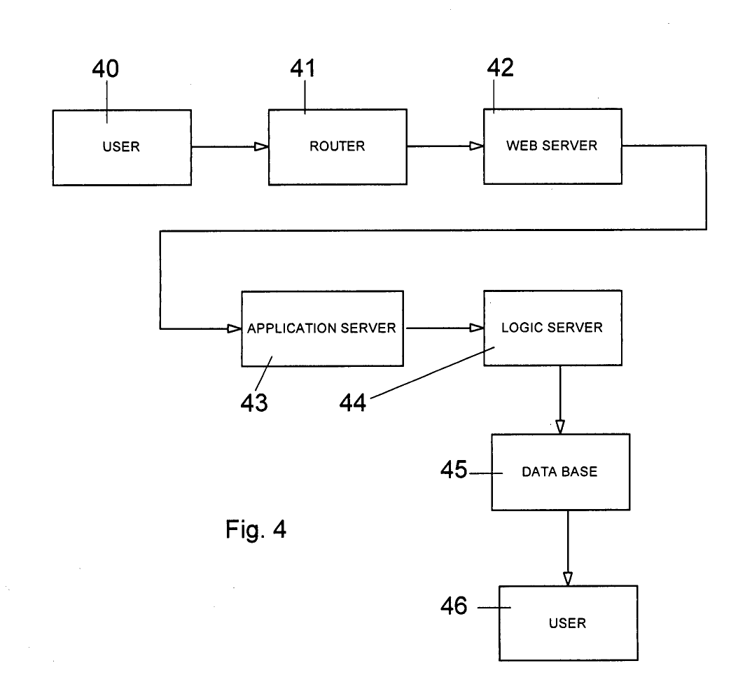

Reference is now made to FIG. 4, which shows a process flow in which a user 40 connects via an Internet router 41 to a web server 42. The web server 42 is associated with an application server 43, logic server 44 and database 45, which all work together to provide the service described above and output a report to a user verifying his bank account.

The application server 43 manages web dialogues between users and applications. The Server uses a relational Data Base 45 and a transaction based application in order to manage the dialogues with the user. The Server is configured as necessary for high-availability and high performance. The Application Server 43 initiates operations of the Logic Servers 45 in order to initiate algorithms needed for the interest and like computations.

Web Server 42 operates the HTTP protocol and is able to serve data to the application server etc. The database 45 provides a mechanism for persistent storage of data that utilizes a Relational Data Model to ensure data integrity. The RDM is used to directly describe the stored data in terms of schema definitions. The software engines that support the database are implemented in a manner that ensures data integrity under the assumption of Normal Form compliance.

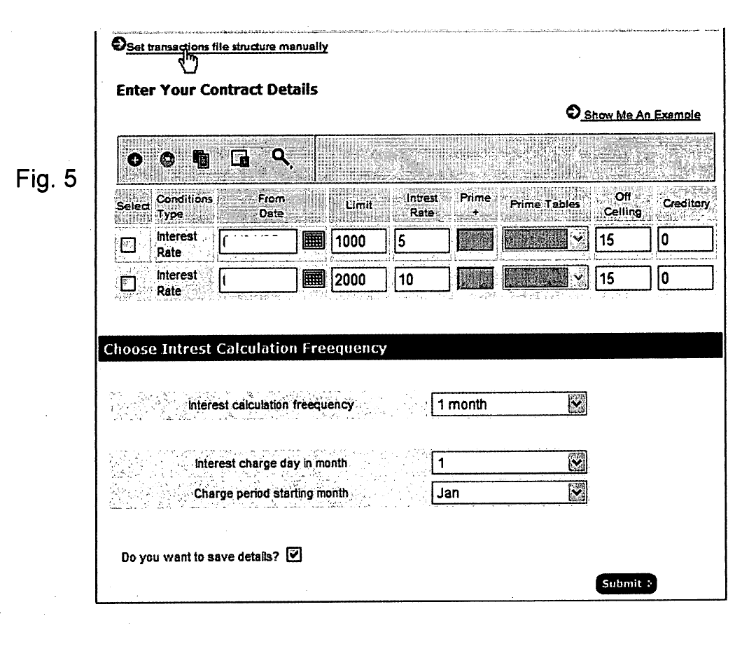

Logic Server 44 receives transaction files sent by the costumer and calculates the bank fees according to contract information given by the costumer. FIG. 5 illustrates a form that a user may use to enter contract details. On this form, the customer defines his contract with the bank. The parameters used include time period the limits of the account and the amount of interest the calculation frequency etc.

A typical file that a user may download from his bank website may include details such as Value date, transaction amounts, credit debit amount and the transaction description. Typical formats for the file are Excel and PDF.

The verification unit of the present embodiments typically audit financial accounts automatically, line by line, to verify the accuracy of interest charges or payments.

Depending on the product and module chosen, the verification unit may upload entire account files from banks or other financial institutions. Audits of the uploaded account may look for errors in interest calculation based on the parameters and terms entered, (e.g. credit line, interest rate, time period, etc.) and produce a letter reporting the account's bottom line or ending balance. As explained above a report may alternatively be produced which rectifies an account retroactively, posting-by-posting, which rectifies and restores an account with amendments, and which produces a wide range of reports on a choice of media.

In a preferred embodiment the verification unit does not just verify an account for correctness, but also reconstitutes or recreates the account to correct any errors. Results can be made available in any number of report formats on several types of media and preferably also suggest alternative recommendations to the user.

The operation of the verification unit is secure and transparent, and reports are provided in formats acceptable to banks, or other financial institutions. The reports may thus be submitted and used as backup for claims of interest overcharges or underpayments. Banks and other lending institutions can use the data and reports to accurately recreate and rectify a faulty account—amicably resolving disputes and eliminating the need for costly and time-consuming litigation.

In a preferred embodiment, the verification unit is a pure-Java based system using XML/XSL technology to enable displaying or viewing data in a manner best suited to the user's browser type, while supporting WAP or any future protocols. The core of the system is a service, as explained above, that receives from the user hand-fed parameters, and files including the financial data. The service analyzes the files in light of the parameters and displays the results and recommendations to the user.

In one embodiment the system is not provided at a server but rather is downloaded to the user to run locally. Preferably the downloaded program demands to be refreshed or deletes itself after a predetermined time.

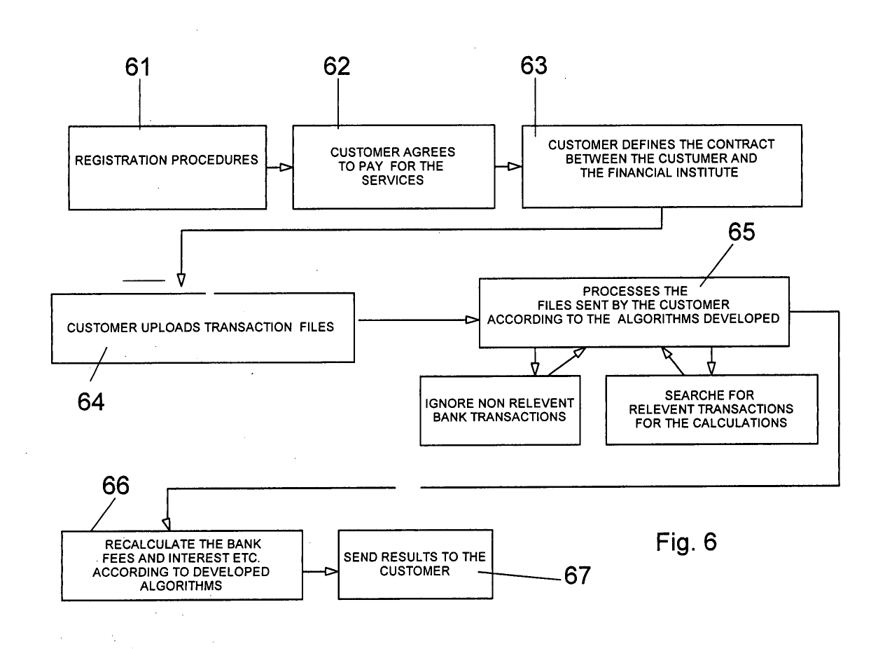

Referring now to FIG. 6, and a program flow from the user point of view is shown. The user registers, 61, and agrees to pay or pays, 62. The customer enters his contract details such as interest rates 63. The customer uploads transaction files such as the bank account 64. In stage 65 the data is processed. Irrelevant bank transactions are ignored as the algorithm searches for the relevant transactions. Payment of interest would often be a relevant transaction. The interest is recalculated in stage 66 and the results are sent to the customer in stage 67.

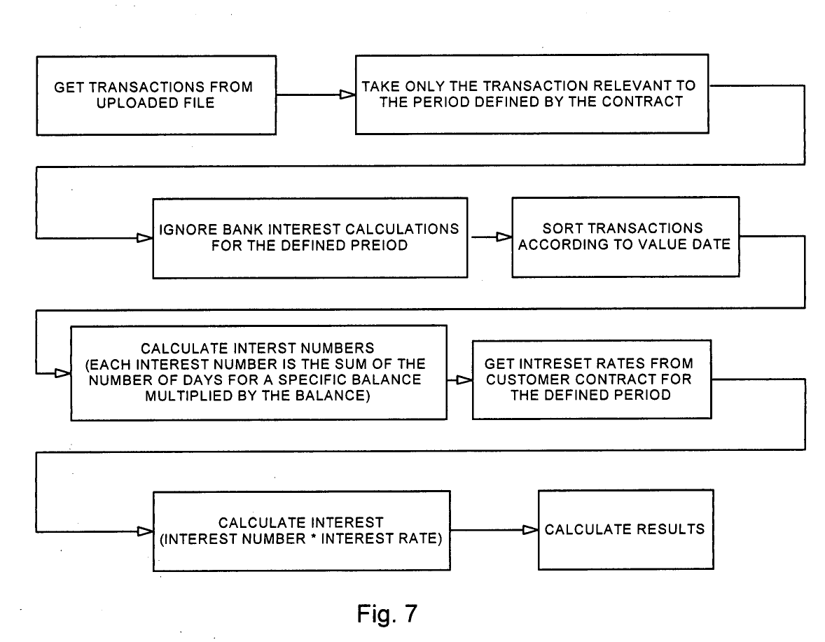

FIG. 7 illustrates in greater detail stage 65 of FIG. 6. In FIG. 7, the transactions are obtained from the uploaded file. Only those transactions pertaining to any defined relevant period are considered. Bank interest calculations over the period are ignored. The transactions are sorted according to value date, assuming they are not already in such an order beforehand. Interest numbers are then calculated, where each interest number is the sum of the number of days for a specified balance multiplied by the balance. Interest amounts are obtained from the customer's parameter input for the defined period. The interest rate is set as interest number times interest rate and the overall interest is then calculated.

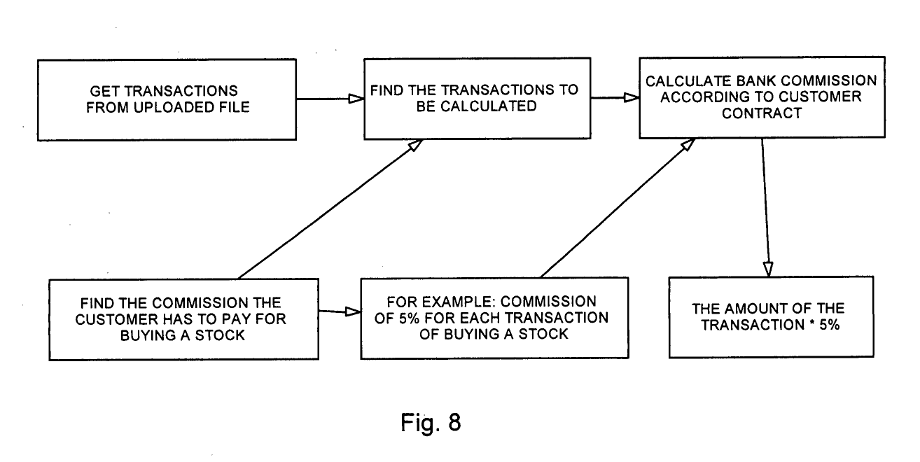

Reference is now made to FIG. 8 which shows an equivalent calculation for a different kind of activity. In the case of FIG. 8, the transaction is the buying of a stock. In this case the relevant transactions are identified from the uploaded file as before and the bank commission is obtained from the customer contract. The commission is calculated independently based on the amount of stock bought.

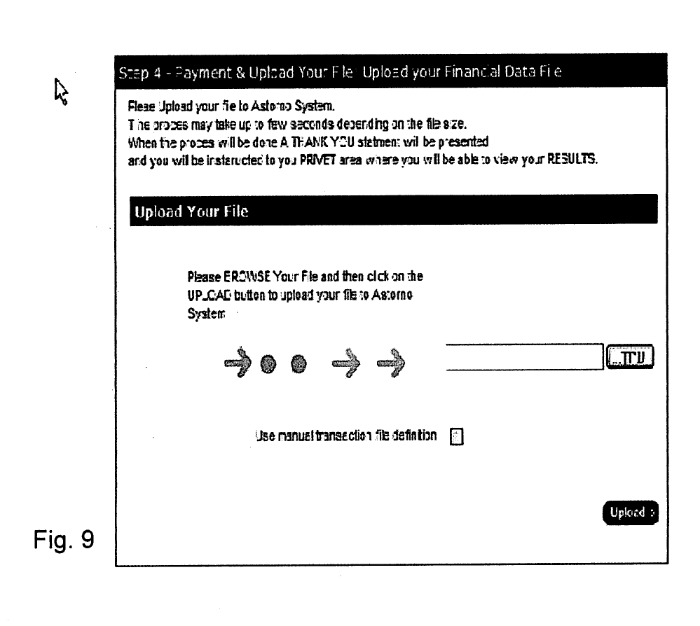

Reference is briefly made to FIG. 9 which shows an interactive form for uploading a file to the website. The user is able to browse to find the file, or can name its path explicitly and when satisfied is able to upload the file.

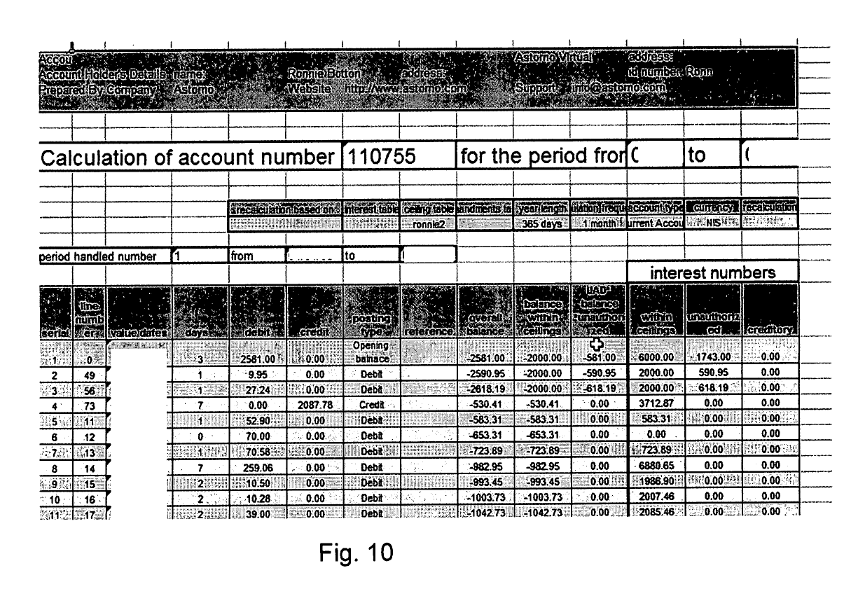

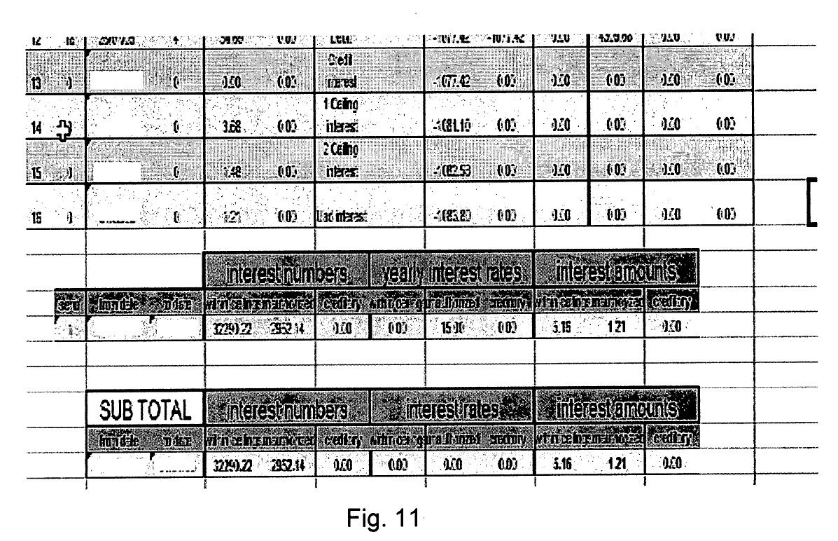

Reference is now made to FIGS. 10 and 11, which illustrate a typical output of the verification unit 10. As shown the verification unit orders the account according to account ceilings and applies the relevant interest rates as value days. FIG. 11 is a zoom of part of FIG. 10 and shows how the account is annotated so that the customer is better able to understand the bank's calculations.

The overall result is that the consumer's confidence in the bank or other financial institution is improved and any mistakes are easily and painlessly rectified.

It is expected that during the life of this patent many relevant devices and systems will be developed and the scope of the terms herein is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Verification unit for financial accounting comprising:
a first input for receiving a financial account in electronic format,
a second input for obtaining parameters used for preparing said financial account,
a processing unit for independently carrying out accounting based on the data in the financial account and the obtained parameters,
a comparator for comparing the input financial account with the independently carried out accounting to verify the input financial account, and
an output associated with the comparator for outputting the results of the comparison.

2. The verification unit of claim 1, wherein said first and second inputs are configured for remote connection over a network.

3. The verification unit of claim 2, wherein the network is at least one member of the group consisting of the Internet, a wide area network, a local area network, a virtual private network, a wireless network, a wireless local area network and an Intranet.

4. The verification unit of claim 1, configured for download to a user location.

5. The verification unit of claim 1, wherein said processing unit is configured to carry out interest accounting, thereby to verify at least one of the group comprising an interest rate, an interest period, an interest start date, and an interest end date.

6. The verification unit of claim 1, wherein said output is configured to provide a comparison report comprising indications of discrepancies between the input financial account and the independently carried out accounting.

7. The verification unit of claim 1, wherein said output is configured to provide a comparison report comprising comments on discrepancies between the input financial account and the independently carried out accounting.

8. The verification unit of claim 1, wherein said first input unit is configured with a format reader to read said financial account in one of a plurality of account formats.

9. The verification unit of claim 1, comprising a financial planning function to allow users to vary at least one of said parameters or data of said financial account.

10. Verification unit for financial accounting comprising:
a first input for receiving a financial account in electronic format, the account having been generated using predetermined financial parameters,
a processing unit for independently carrying out accounting based on the data in the financial account in order to derive said predetermined parameters, and
an output associated with the comparator for outputting the derived parameter results.

11. A method of providing verification of financial accounting comprising:
receiving a financial account in electronic format,
receiving parameters on which said financial account is supposed to have been based,
independently carrying out accounting using data from said received financial account and said received parameters,
comparing said received account with said independently carried out accounting, and
providing a verification output indicative of said comparing.

12. A server comprising:
an input unit for receiving financial accounting data and parameters for financial accounting;
a processing unit for recalculating said financial accounting data using said parameters, thereby to verify said received financial accounting data.

13. A method of doing business comprising:
receiving financial accounting data and parameters for financial accounting from a customer;
receiving payment from said customer; and
recalculating said financial accounting data using said parameters; and
providing said customer with verification data of said received financial accounting data.
